(19) United States
(12) Patent Application Publication
(10) Pub. No.: US 2007/0192243 A1
(43) Pub. Date: Aug. 16, 2007

(54) Methods and systems for analyzing electronic payment transaction data for errors

(76) Inventors: Rob Garbarino, Bethpage, NY (US); Alan Scott, Riverhead, NY (US); Manju Shashibhushana, Dix Hills, NY (US); Brian Carman, Levittown, NY (US)

Correspondence Address: BRANDON N. SKLAR. ESQ. (PATENT PROSECUTION);KAYE SCHOLER, LLP, 425 PARK AVENUE, NEW YORK, NY, 10022-3598, US

(21) Appl. No.: 10/935,806

(22) Filed: Sep. 7, 2004

(51) Int. Cl. G07G 1/00; G06F 17/30

(52) U.S. Cl. 705/39; 705/10

(57) ABSTRACT

Methods are provided for identifying errors in data relating to at least one electronic payment transaction request. In one embodiment, the method includes receiving data relating to at least one electronic payment request and analyzing the electronic payment request data based upon a predefined set of rules. Specifically, the data that makes up the electronic payment request data is reviewed to ensure that it meets the predefined rules. A report is then generated that identifies which predefined rule(s) were not met for each type of electronic payment request data that is received. In one example, this process may be repeated until the electronic payment request data of the data file meets the predefined rules for the data types that are included in the data file. Systems are also disclosed.

### FIELD OF THE INVENTION

The invention relates to methods and systems for analyzing electronic transactions, and more specifically, to methods and systems for determining whether hypothetical or actual electronic payment transaction data meets specified formatting criteria.

### BACKGROUND OF THE INVENTION

In the course of engaging in the sale of goods and services, merchants typically accept various forms of payments from consumers. Some of these forms of payment include the use of cash, check, debit card, credit card and the like

Many of these forms of payments are electronic in nature (credit card, debit card, electronic check payments, stored value cards, loyalty points redemptions, electronic benefits transfers, for example) and afford certain conveniences to consumers. For example, when electronic payments are accepted, consumers do not have to determine whether they have a sufficient amount of cash on their person, do not have to transfer funds to the merchant immediately, and at times, can purchase goods or services using a line of credit.

Such electronic payment offerings also provide benefits to merchants. For example, by offering an array of payment options to consumers, merchants typically recognize an increase in sales opportunities.

Nevertheless, along with these advantages, electronic payment systems and methods include various complexities. For example, the process of handling electronic payment transactions typically requires involvement of additional parties—including a data transaction provider—that handle the processing of data to effectuate the electronic payment transaction. Accordingly, with a typical electronic payment transaction initiated by a consumer, a merchant and a data transaction provider communicate with one another to ensure that the electronic transaction is authorized (for example, that the transaction involves an authorized consumer (not an impersonator)), that sufficient information is presented to memorialize the transaction (for example, for reporting the transaction on a consumer's billing statement), and that sufficient information is collected to effectuate payment of interchange, or some other fee, between a merchant, consumer (or their banks) and data transaction provider involved in the transaction, and the like.

It should be noted that as used herein: the term “electronic payment transactions” may include transactions involving the electronic payment of funds or the electronic credit of funds; the term “electronic payment requests” may be any communication of data, typically set (or record) of data, that effectuates electronic payment transactions; and the term “payment” used herein may include a transaction involving the payment of funds or the credit of funds.

Complexities regarding the completion of electronic payment transactions are not only due to the number of parties involved in the transactions. For example, typically, electronic transactions may only be processed if electronic data records that make up the electronic transaction meet a specified criteria—for instance, format. In most instances, if the format of one or more data records respecting an electronic payment transaction does not meet a specified set of criteria, the transaction may be processed incorrectly or may not be processed at all. Accordingly, in the course of processing electronic payment transactions, it is important that data records relating thereto meet a predetermined format, as defined by, for example, a set of standards established by the data transaction provider, or some other entity or group of entities involved in the transaction.

Typically, the format for electronic payment transaction records generated by a given merchant are unchanged for each type of transaction request. Thus, once the merchant's systems and processes are established such that electronic payment transactions are effectuated using properly formatted data, it becomes less likely that such data needs to be analyzed or changed to ensure that it meets a predefined criteria. Nevertheless, when a given merchant's electronic payment systems or processes are put in place for the first time or are changed (due to, for example, a system change that is either planned or unplanned), it often becomes necessary to ensure that the data records are appropriately formatted and error free.

Due to the large number of data records that are involved in effectuating electronic payment transactions (for example, data records that identify and describe the merchant involved in the transaction, data records that provide details concerning the transaction (such as the date, amount, etc.), data records that provide detail for memorializing the transaction, and the like), correctly formatting each of these requests may be a daunting task. The process may be time consuming, expensive and/or frustrating to merchants and data transaction providers.

### SUMMARY OF THE INVENTION

Accordingly, techniques are provided for analyzing data to identify the presence of one or more errors in electronic payment transaction requests. In accordance with an embodiment of the invention, the data relates to hypothetical or actual electronic payment transaction requests and is analyzed for the purpose of determining whether the formatting of the received data meets a predetermined set of rules. In one embodiment, the method and system involves analyzing data relating to an electronic payment request including receiving a record comprising data relating to an electronic payment request and identifying a record type associated with the record. One or more rules based on the record type is then identified, wherein the rules relate to at least one formatting characteristic of the data, and a determination is made whether the data relating to the electronic payment request meets any such rule(s). A report is then generated that identifies each of the at least one rule that is not met.

It should be noted that the terms “format” and “formatting” used herein in connection with electronic payment transaction data and data records relate to the general makeup and arrangement of the data in the record, such as the length of the record, the number of fields that make up a given record, the length of each field, which data elements of each field must be a letter character and which must be a number character, which fields must or may be comprised of blanks or null data, and whether the data must equal a certain value or range of values, etc.

In one embodiment of the invention, this technique is effectuated by an apparatus or system that does not perform the processing of electronic payment transactions; rather it is performed by a testing apparatus or system that is dedicated to analyzing electronic payment request data for errors. In addition, as mentioned above, the technique may be applied to hypothetical payment transaction data—i.e., data that is compiled to emulate data records relating to electronic payment request for test purposes—not for processing payment. Alternatively, the technique may be applied to actual payment transaction data—i.e., data that makes up one or more data records relating to electronic payment request and which is processed for payment either before or after processing the electronic payment request.

### BRIEF DESCRIPTION OF THE DRAWINGS

Further objects, features and advantages of the invention will become apparent from the following detailed description taken in conjunction with the accompanying drawings showing illustrative embodiments of the invention, in which:

FIG. 1 is a block diagram of an electronic payment request analysis system, in accordance with an embodiment of the invention;

FIG. 2 is an example of an electronic payment transaction file used by the system of FIG. 1, in accordance with another embodiment of the invention;

FIGS. 3a and 3b illustrate an example of a portion of an electronic payment transaction analysis report generated by the system of FIG. 1, in accordance with an embodiment of the invention;

FIG. 4 is a flowchart of an example of a method of processing an electronic payment transaction file, in accordance with an embodiment of the invention;

FIG. 5 is an example of a graphical user interface for submitting a data file for analysis, in accordance with an embodiment of the invention;

FIG. 6 is a flowchart of an example of a method of analyzing electronic payment transaction records, in accordance with an embodiment of the invention; and

FIG. 7 is an example of a graphical user interface for transmitting an electronic payment transaction analysis report, in accordance with an embodiment of the invention

### DETAILED DESCRIPTION OF THE PREFERRED EMBODIMENTS

Methods and systems for analyzing data relating to electronic payment transaction requests are described below. The data is analyzed for detecting the presence of one or more data errors. In accordance with an embodiment of the invention, the data relates to hypothetical electronic payment transaction requests and is analyzed for the purpose of determining whether the formatting of the received data meets a predetermined set of rules. In such instance, the data may be analyzed by an entity or system that is different than an entity or system that processes electronic payment transaction requests between merchants and consumer for settlement. In another embodiment, actual electronic payment transaction requests are analyzed—by either a data transaction provider that also processes such electronic requests for settlement, or by an entity or system that is configured to analyze the data for errors but does not process it for settlement purposes.

It should be noted that as used herein: the term “electronic payment transactions” may-include transactions involving the electronic payment of funds or the electronic credit of funds; the term “electronic payment requests” may be any communication of data, typically set (or record) of data, that effectuates electronic payment transactions; and the term “payment” used herein may include a transaction involving the payment of funds or the credit of funds.

In one embodiment, the system involves receiving a data file comprising data relating to at least one electronic payment request, and analyzing the electronic payment request data for one or more errors based upon a predefined set of rules. Specifically, the data record that makes up the electronic payment request data is reviewed to ensure that it meets the predefined rules. A report is then automatically generated that identifies which predefined rule(s) are not met, if any, for each type of electronic payment request data that is received. This process, in some instances, is repeated until the electronic payment request data of the data file meets the predefined rules for the data types that are included in the data file. A system for processing this method is also described.

The System

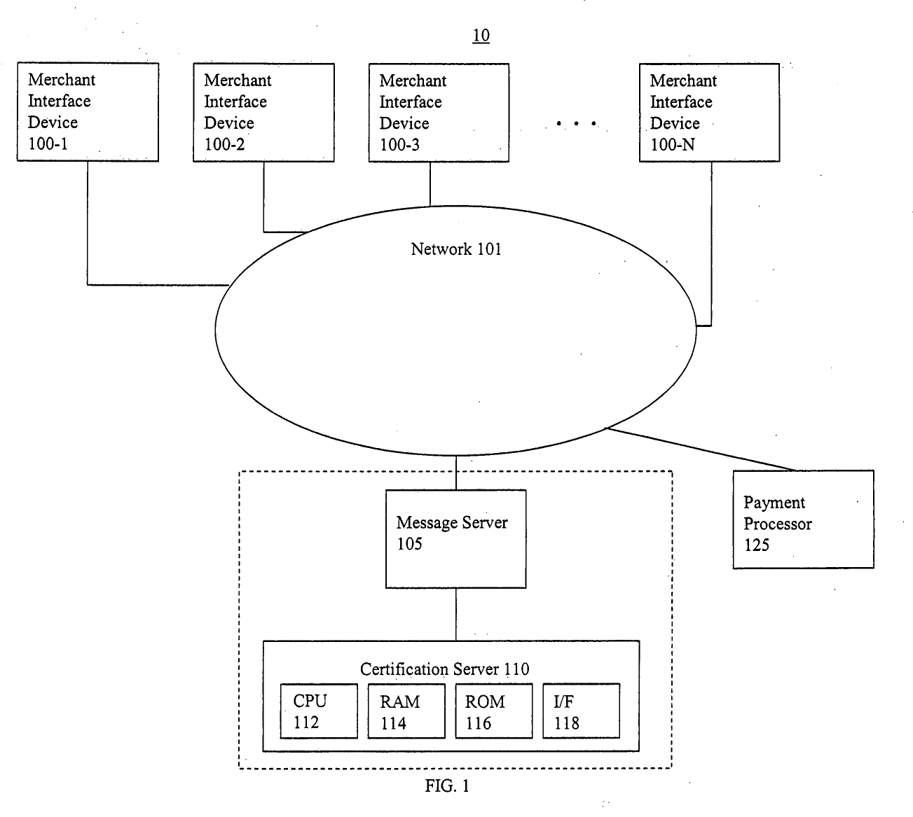

FIG. 1 is a block diagram of an electronic payment analysis system 10 that incorporates features of the present invention. System 10 is programmed to monitor communications, such as emails, having electronic payment data files to be analyzed. System 10 then extracts and analyzes such data files, and generates a report that identifies errors included in the data that makes up the electronic payment data files. In accordance with an embodiment of the invention, one or more merchants, via merchant interface device 100-1 through 100-N, communicate with a certification server 110, via network 101 and message server 105.

A merchant is typically any individual or entity that makes a request for authorization and/or settlement of an electronic payment transaction. Typically, a merchant has one or more merchant interface devices 100-1 through 100-N for submitting electronic payment requests to a payment processor 125 controlled by a data transaction provider for processing and settling electronic payment transactions. The data transaction provider is a liaison between merchants and bank card associations (such as Visa and MasterCard), and computes the interchange (fee) associated with each credit card transaction processed by merchants. In FIG. 1, each of merchant interface devices 100-1 to 100-N may be a computer or server that is programmed to receive and transmit electronic payment transaction data for transaction processing and settlement.

In accordance with an embodiment of the invention, merchant interface device 100-1 through 100-N may also be used to request that a data transaction provider analyze electronic payment request data, rather than effectuate an electronic payment transaction. In accordance with an embodiment of the invention, the data transaction provider or a separate entity operates message server 105 and certification server 110 to analyze electronic payment transaction data for errors. The components to perform such an analysis is illustrated in FIG. 1. Thus, merchant interface devices 100-1 through 100-N are programmed to transmit electronic payment data to merchant server 105 and certification server 110 via network 101. Network 101 may provide a connection by means of a TCP/IP connection using a wide area network, or some other network.

Message server 105 is programmed to receive communications from one or more of merchant interface devices 100-1 through 100-N and, as described more fully below, to determine whether the received communication contains a data file to be analyzed by certification server 110. Message server 105 is also programmed to receive electronic payment transaction data analysis reports from certification server 110 and for forwarding such reports to the appropriate merchant interface device 100. Certification server 110 is programmed to receive electronic payment request test data, analyze the test data and generate a report that provides test data results, as described more fully below.

Although FIG. 1 illustrates a system comprising a message server 105 that is separate from certification server 110 for testing electronic payment request data files (including receiving and analyzing test data, and generating and transmitting test results), the functionality of the system of FIG. 1 described herein may be performed by any number of servers, including a single server, the two servers shown, (i.e., servers 105 and 110), or more servers. Message server 105 and certification server 110 may therefore be separate processing devices as illustrated in FIG. 1, or may be combined into a single device. In addition, servers 105 and 110 may be mainframes, servers, computers or other devices having computing capability.

Certification server 110 preferably includes standard hardware components, such as central processing unit (CPU) 112, a random access memory (RAM) 114, a read only memory (ROM). 116 and interface (I/F) 118. Although not shown, CPU 112 is preferably linked to each of RAM 114, ROM 116 and I/F 118, either by means of a shared data bus, or dedicated connections. CPU 112 may be embodied as a single commercially available processor. Alternatively, in another configuration, the CPU 112 may be embodied as a number of such processors operating in parallel.

ROM 116 is operable to store one or more instructions, discussed further below in conjunction with FIGS. 1, 4 and 6, which the CPU 112 is operable to retrieve, interpret and execute. For example, ROM 116 preferably stores processes for receiving electronic payment request test data, analyzing the test data and generating a report that provides test data results.

CPU 112 preferably includes a control unit, an arithmetic logic unit (ALU), and a CPU local memory storage device, such as, for example, a stackable cache or a plurality of registers, in a known manner. The control unit is operable to retrieve instructions from ROM 116. The ALU is operable to perform a plurality of operations needed to carry out instructions. The CPU local memory storage device is operable to provide high-speed storage used for storing temporary results and control information.

I/F 118 connects central server 110 to message server 105. Such connection may be by means of a TCP/IP connection using a wide area network, for example.

In accordance with an embodiment of the invention, message server 105 comprises the same type of components as central server 110. Thus, CPU, RAM, ROM and interface devices—similar to components 112, 114, 116 and 118, respectively—as described above, are incorporated in such server. Message server 105, however, preferably stores instructions/processes for receiving electronic payment transaction analysis reports from certification server 110 and for forwarding such reports to the appropriate merchant interface device among merchant interface devices 100-1 through 100-N.

Electronic Payment Transaction Files and Electronic Payment Transaction Analysis Reports

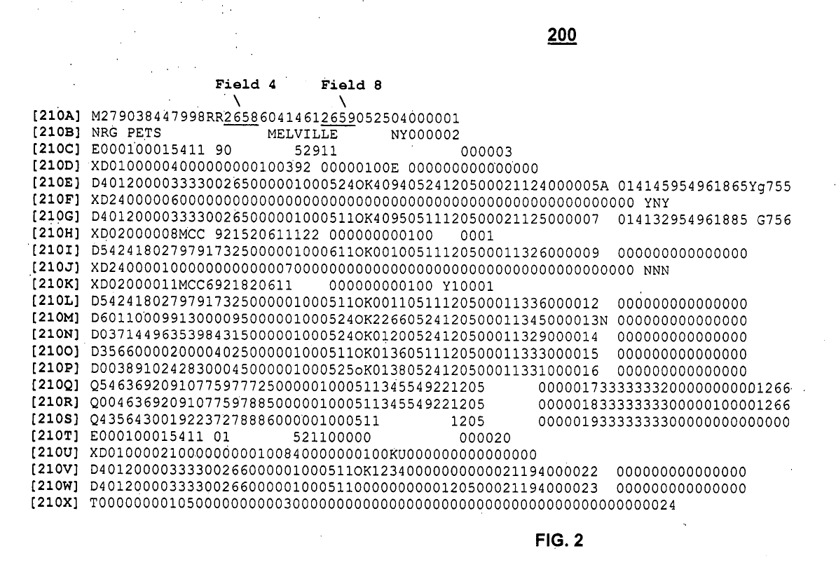

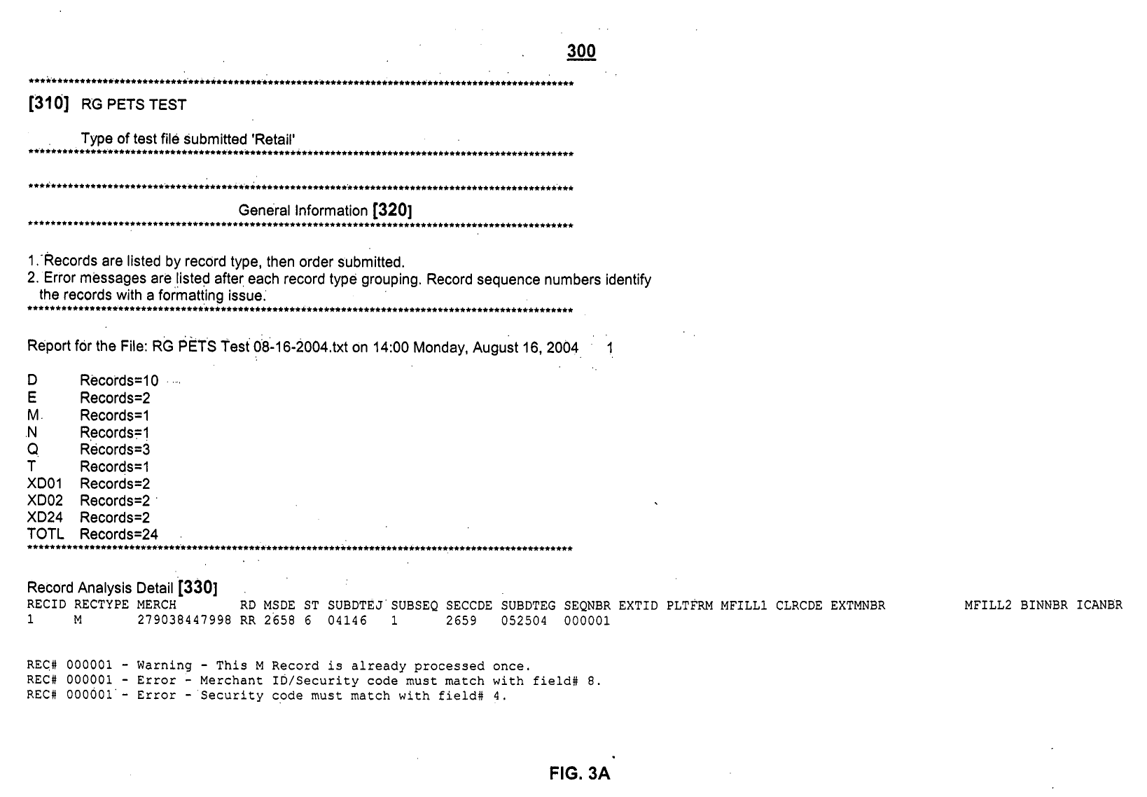

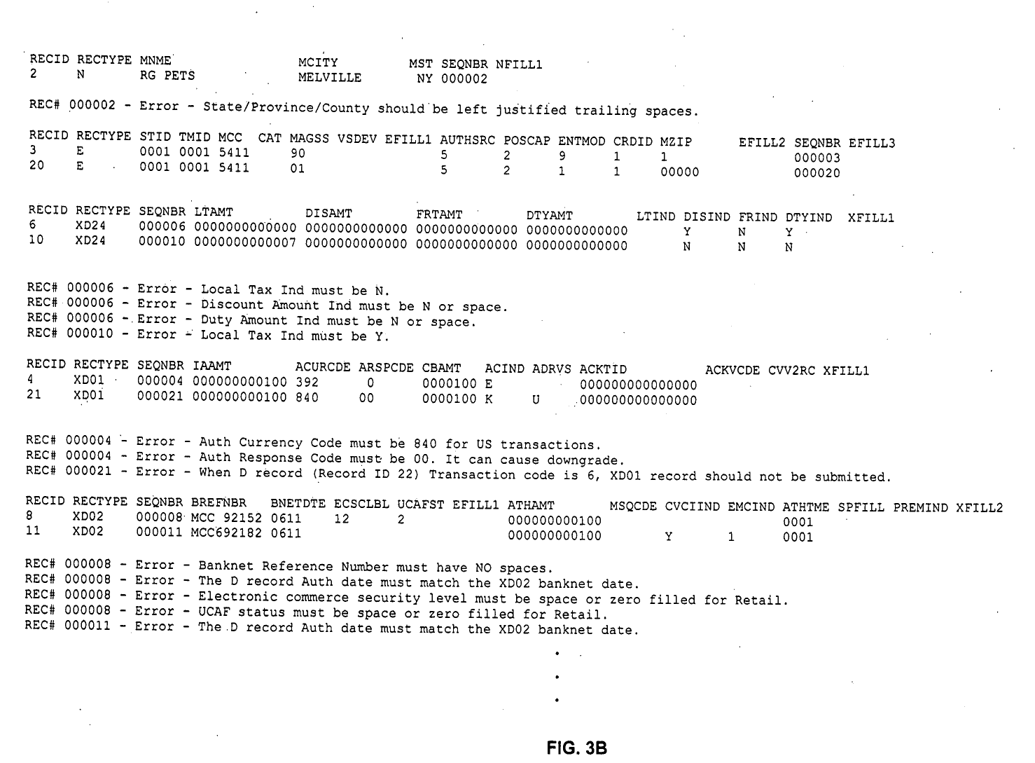

FIG. 2 illustrates an example of an electronic payment transaction file 200 which is analyzed by central server 110, and FIGS. 3a and 3b illustrate an example of a portion of an electronic payment transaction analysis report generated by the central server 110, in response to analyzing file 200, in accordance with an embodiment of the invention.

When a merchant submits electronic payment requests to message server 105 which are transmitted to certification server 110 for processing, such requests comprise a plurality of data records. These data records contain the data required to process electronic payment requests (hypothetical or actual) and may include data that: identifies the name of the merchant involved in the transaction, provides a description of the merchant that is to appear on the consumer's statement (which may or may not be identical to the merchant's name), identifies the merchant type (for example, restaurant, drugstore, etc.), provides transaction details (for example, date of transaction, consumer account number), and the like. The accuracy of this data is essential for proper processing of the electronic payment transactions.

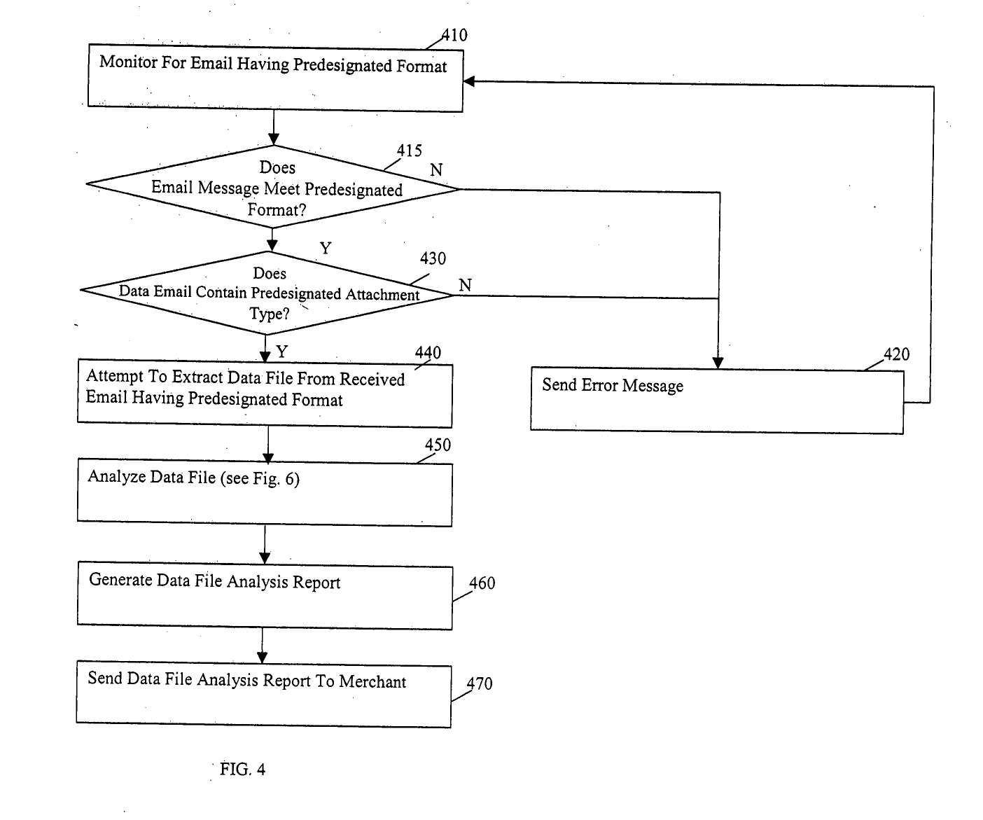

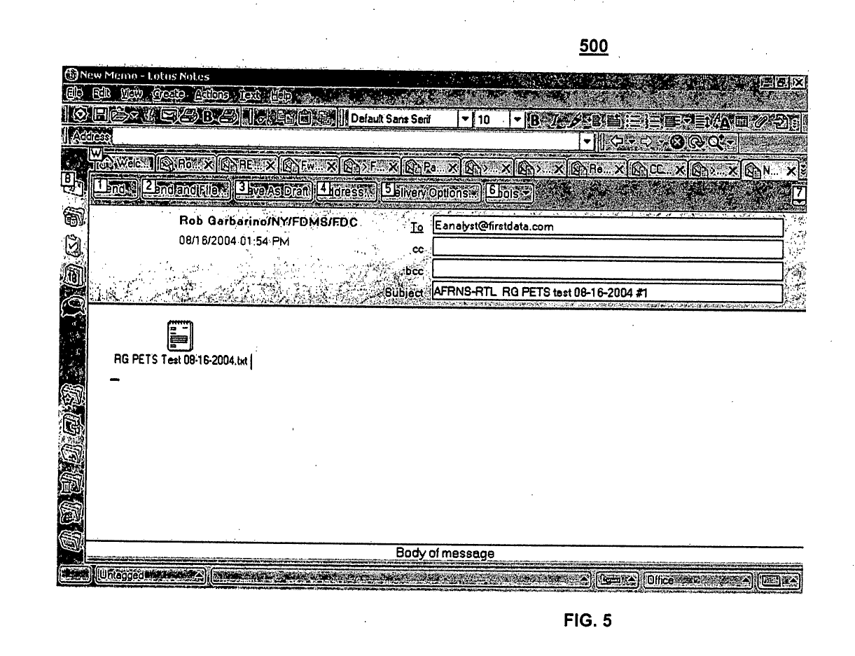

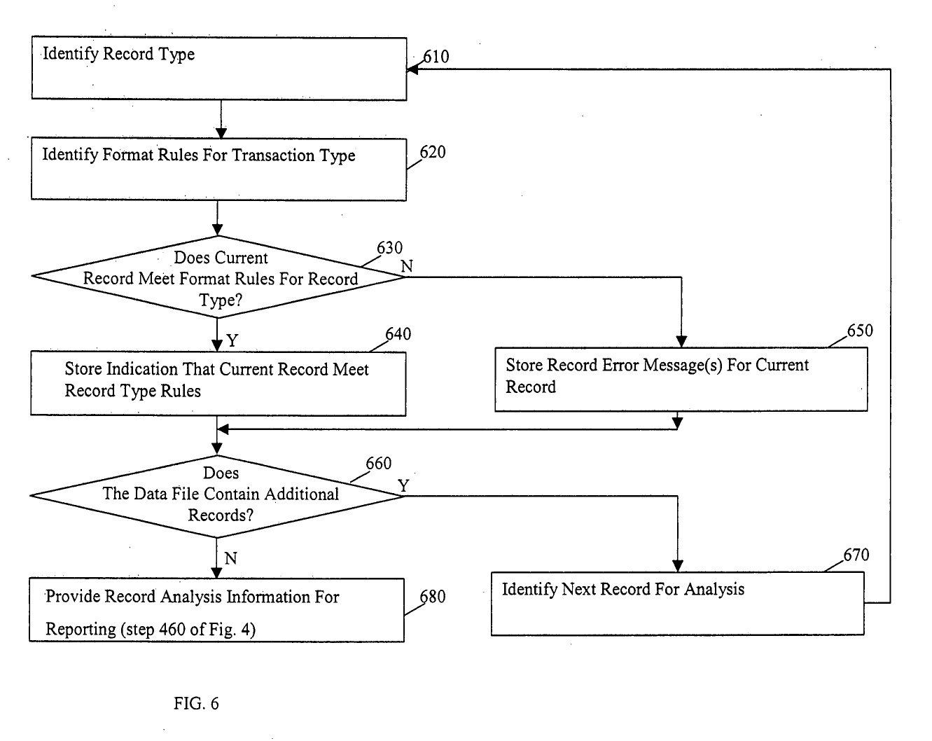

Accordingly, the processes described below (with reference to FIGS. 4 and 6) may be used to ensure the accuracy of electronic payment transaction data records submitted by a merchant for processing. Typically, the described process relates to the evaluation of one or more electronic payment transaction data records that are submitted as a test file and are not to be processed for settlement. In this case, the hypothetical request is submitted so that the format of the records may be evaluated. In an alternative embodiment, actual electronic payment transaction requests may be analyzed before or after they have been submitted for processing a data transaction provider.

By using the processes described herein, the need for a person or persons to manually review many lines of data to ensure the accuracy of the data records used for effectuating electronic payment transactions may be obviated.

File 200 (of FIG. 2) includes a plurality of data records that contain data relating to processing individual (hypothetical or actual) electronic payment transactions. File 200, in this example, comprises twenty four data records 210A through 210X, which comprise a plurality of fields of data, as defined by a predetermined set of rules. Thus, in the example, record 210A comprises 42 alphanumeric characters, and field 4 includes the sixteenth through the nineteenth characters while field 8 includes the twenty-seventh through thirtieth characters. If one or more of these data records are improperly presented when effectuating an electronic payment transaction, then the processing of one or more electronic payment transactions involving such data records would most likely fail or be processed incorrectly. Accordingly, as described more fully below, each data record is identified by record type and then the accuracy of the data record format is assessed, based upon the record type.

It should be noted that the terms “format” and “formatting” used herein in connection with electronic payment transaction data and data records relate to the general makeup and arrangement, such as the length of the record, the number of fields that make up a given record, the length of each field, which data elements of each field must be a letter character and which must be a number character, which fields must or may be comprised of blanks or null data, and whether the data must equal a certain value or range of values, etc.

In response to assessing the records of data file 200, a report is generated which identifies any errors detected in the data file. The errors are determined by reviewing a set of formatting rules that relate to each type of data record that is included in the data file.

An example of a portion of a report that is generated by certification server 110 and transmitted to a merchant by message server 105 is illustrated in FIGS. 3A and 3B. In one example, electronic payment transaction analysis report 300 has three sections: title section 310, general information section 320 and record analysis detail section 330.

Title section 310 includes the name of the merchant for which the test report is generated and a description of such merchant. Thus, turning to FIG. 3A, title section 310 discloses that RG Pets is the merchant for which report 300 is generated and that RG Pets is considered a “retail” merchant.

General information section 320 provides a summary of the file types that are included in data file 200. The general information includes a listing of the data record types analyzed by certification server 110 and the number of each of the data record types. For example, electronic payment transaction analysis report 300 indicates that the data file analyzed by certification server 110 comprises ten “D” records (210E, 210G, 210I, 210L, 210M, 210N, 210O, 210P, 210V and 210W), two “E” records (records 210C and 210T), one “M” record (record 210A), one “N” record (record 210B), three “Q” records (records 210Q, 210R and 210S), one “T” record (record 210X), two “XD01” records (records 210D and 210U), two “XD02 ” records (records 210H and 210K) and two “XD24 ” records (records 210F and 210J)—for a total of twenty four records. A description of these record types is as follows:

| Record | |
|---|---|
| Type | Description |
| D | Credit Card Detail Information (card number, date, |
| | amount, etc. re credit card transaction) |
| E | Enriched Deposit Information |
| M | Merchant Account (unique number for identifying |
| | merchant) |
| N | Merchant Description Information (merchant name |
| | and location) |
| Q | Debit Card Detail Information (card number, date, |
| | amount, etc. re debit card transaction) |
| T | Information Identifying The Total Dollar Amount |
| | Of Records Included In A File |
| XD01 | Supplemental Visa Detail Information (Visa |
| | authorization data) |
| XD02 | Supplemental MasterCard Detail Information |
| | (MasterCard authorization data) |
| XD24 | Purchase Card Sales Tax Information |

It should be noted that, although nine record types are provided and are therefore listed and described above, many other record types may be used by merchants in effectuating electronic payment transactions and may therefore be included in other data files (not shown) to be analyzed by central server 110. Merchants, data transaction providers and others skilled in the art are aware of the numerous data record types that are utilized in connection with such transactions.

Electronic payment transaction analysis report 300 also includes record analysis detail 330, which identifies those records of a data file that contain one or more format errors. For example, as provided by report 300, the data record having record ID “1” is type “M” and contains two errors and one warning. The error indicates to the merchant receiving the report (in this case RG Pets) that the merchant ID/security code (which is made up of the characters of field 4) must match merchant security code (which is made up of the characters of field 8) and vice versa—that is, field 8 must match field 4. A warning is also provided to the merchant that this record had already been processed once before. This warning alerts the merchant to make sure that the same record is not processed multiple times on the consumer's behalf. Because, in this instance, the data records are part of a test file (rather than an actual payment transaction file), it is not uncommon for the same record to be processed (analyzed) multiple times. The basis for generating these errors and warnings arises from the provision of a plurality of rules associated with each data record type. These rules relate to the format of each record type for a given record type: the length of the record, the number of fields that make up the record, the length of each field, which data elements of each field must be a letter character and which must be a number character, which fields must or may be comprised of blanks or null data, and the like, and such rules are stored by ROM 116 or some other memory or storage (not shown) for access by CPU 112.

In addition to record ID “1,” record ID's 2, 4, 6, 8, 10, 11 and 21 generated error messages, and record ID's 3 and 20 did not. (It should be noted that, because FIGS. 3A and 3B only illustrate a portion of a report, record ID's 5, 7, 9, 12-20 and 22-24 are not illustrated—even though they are part of the data file 200 that was analyzed and would be part of a complete electronic payment transaction analysis report generated by system 100 of FIG. 1.)

The processes of receiving data file 200, analyzing the data records of file 200, and generating report 300 will now be further described with reference to FIGS. 1 through 7. It should be noted that, in a typical situation, a merchant will use such a report to correct data records of a test file, wherein the data records have one or more data record formatting errors. In some instances, the merchant may submit a data file multiple times to certification server 110, wherein each time the number of formatting errors will typically be reduced. Test analyses on a data file may be repeated until all format errors are identified.

Electronic Payment Transaction Analysis Process

FIG. 4 is a flowchart illustrating an example of a method of processing an electronic payment transaction file, such as file 200, for the detection of errors, in accordance with an embodiment of the invention. In this example, message server 105 is programmed to monitor for messages having a predetermined format (step 410). Thus, in accordance with an embodiment of then invention, message server 105 monitors for an email, wherein the subject line of the email includes a predetermined message (step 415). For example, in one embodiment of the invention, message server 105 monitors incoming email messages for emails that have a subject line that begins with the following string: “AFRNS-RTL.” An example of such an email message is illustrated by graphical user interface (GUI) 500 of FIG. 5. As illustrated by GUI 500, the subject message begins with “AFRNS-RTL,” which therefore indicates to message server 105 that the email contains a data file for extraction by server 105 and then analysis by certification server 110. Additional information may follow the “AFRNS-RTL” string, such as information relating to the name of the merchant submitting file 200 and the date of such submission, as shown by GUI 500. In this instance, the “RTL”=0 suffix indicates that the records relate to those processed for a retail merchant. Other suffixes, such as DMK for direct marketing merchants and ECM for e-commerce merchants may be used, for example. In addition, the last two letters of the prefix (“NS”) identify the server that is handling the electronic payment transaction request. In this case, “NS” is an abbreviation for North Settlement server Other examples include: “NA” for North Authorization server, “SS” for South Settlement server, and “SA” South Authorization server.

It should be noted that, although the receipt of email is monitored, system 100 may be configured to monitor for other electronic transmission types, such as postings to an extranet, intranet, the Internet, and the like. Alternatively, data to be analyzed may be directed to a location that is dedicated for receiving electronic payment request data files for evaluation, and therefore no monitoring of transmission type is required.

If, in this instance, an email is received without the appropriate subject line information, then an error message is generated (step 420). If, however, the received email is in the appropriate format, then message server. 105 determines whether the email includes an attachment that is in a predetermined format (step 430), such as a .txt format. If the attachment is in the correct format, then message server 105 attempts to extract data file 200 from the received email (step 440). If, however, the attachment is not in the correct format, then message server 105 sends an error message to the merchant interface device (for example, one or more merchant interface.device 100-1 through 100-N) of the merchant that made the request (step 420), and the message server then continues to monitor for subsequent emails having the predetermined format described above (step 410).

Once message server 105 successfully extracts a data file from a received email, the file contents are transmitted to certification for server 110 for data record analysis (step 450). The process for analyzing data records stored by a data file, such as file 200, is illustrated by the flowchart of FIG. 6.

For example, certification server 110 identifies the record type for a given data record included in the data file to be analyzed (step 610). In accordance with an embodiment of the invention, the record type is identified from the first field of a data record. Thus, referring to FIG. 2, the first data record (record 210A) is an “M” record.

Next, CPU 112 identifies the format rules for the data record type to be analyzed (step 620)—in this case, “M” record type—and determines whether such record meets the format rules for the record type (step 630). If certification server 110 determines that the record being analyzed meets the record type rules associated thereto, certification server 110 stores an indication that the record type rules have been met (step 640). On the other hand, if certification server 110 determines that the record being analyzed does not meet the record type rules associated thereto, certification server 110 maintains a record error message for subsequent reporting to the merchant that submitted the data file for analysis (step 650).

Next, certification server 110 determines whether data file 200 contains additional records to be analyzed. If so, the next data record is identified for analysis (step 670) and the analysis process returns to step 610. Once, however, the final data record of file 200 is analyzed, certification server 110 compiles the derived analysis data for automatically generating an analysis report (step 680).

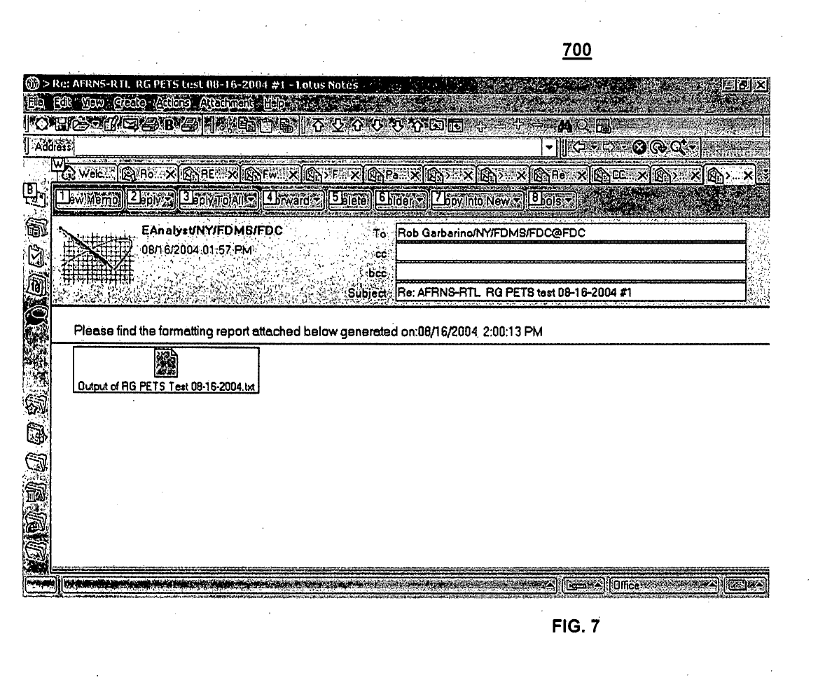

In accordance with an embodiment of the invention, such report is transmitted by email. An example of such an email is illustrated by GUI 700 of FIG. 7. Of course, an analyses report may be transmitted by other means other than email.

Returning to FIG. 4 (at step 460), a data file analysis report is generated based upon the analysis performed by certification server 110 of each data record of file 200. Finally, the data file analysis report generated by certification server 110 is transmitted to message server 105, which transmits the report to the merchant interface device 100 of the merchant that generated the data file (step 470). As described above, a merchant may choose to repeat the processes described herein one or more times—for example, until the merchant is comfortable that all data record errors have been detected and corrected.

The foregoing merely illustrates the principles of the invention. It will thus be appreciated that those skilled in the art will be able to devise numerous other arrangements which embody the principles of the invention and are thus within the spirit and scope of the invention, which is defined by the claims below.

What is claimed is:

1. A method for analyzing data relating to an electronic payment request, the method comprising:
receiving a record comprising data relating to an electronic payment request;
identifying a record type associated with the record;
identifying at least one rule based upon the record type, wherein the at least one rule relates to at least one formatting characteristic of the data;
determining whether the data relating to the electronic payment request meets the at least one rule; and
generating a report that identifies each of the at least one rule that is not met.

2. The method of claim 1, wherein the electronic payment request relates to electronic payment of funds for the purchase of goods or services.

3. The method of claim 1, wherein the electronic payment request relates to electronic debit of funds for the refund of goods or services.

4. The method of claim 1, further comprising:
identifying an electronic payment request type associated with the electronic payment request; and
wherein the record type is at least partially based on the electronic payment request type.

5. The method of claim 1, further comprising:
generating an error message if the record is not received in a predetermined manner.

6. The method of claim 1, wherein the record is received by electronic transmission.

7. The method of claim 6, wherein:
the electronic transmission comprises an email delivery, and
a predetermined message is transmitted with the record.

8. The method of claim 1, wherein the report is transmitted electronically.

9. The method of claim 1, wherein the formatting characteristic comprises at least one of the following: a length of the record, an alphanumeric requirement associated with the record, and a null data requirement associated with the record.

10. The method of claim 1, comprising:
receiving a plurality of records related to the electronic payment request.

11. A method for analyzing data, wherein the data is received by a system that does not process electronic payment transactions, the method comprising:
receiving, by the system, a record comprising data relating to an electronic payment request;
identifying a record type associated with the record;
identifying at least one rule based upon the record type, wherein the at least one rule relates to at least one formatting characteristic of the data; and
determining whether the data relating to the electronic payment request meets the at least one rule.

12. The method of claim 11, further comprising:
identifying an electronic payment request type associated with the electronic payment request; and
wherein the record type is at least partially based on the electronic payment request type.

13. The method of claim 11, further comprising:
generating an error message if the record is not received in a predetermined manner.

14. The method of claim 11, further comprising:
generating a report that identifies each of the at least one rule that is not met.

15. The method of claim 14, wherein the report is transmitted electronically.

16. The method of claim 11, wherein the formatting characteristic comprises at least one of the following: a length of the record, an alphanumeric requirement associated with the record, and a null data requirement associated with the record.

17. A method for analyzing data relating to a hypothetical electronic payment request, the method comprising:
receiving a record comprising data relating to the hypothetical electronic payment request;
identifying a record type associated with the record;
identifying at least one rule based upon the record type, wherein the at least one rule relates to at least one formatting characteristic of the data; and
determining whether the data relating to the electronic payment request meets the at least one rule.

18. The method of claim 17, further comprising:
identifying an electronic payment request type associated with the electronic payment request; and
wherein the record type is at least partially based on the electronic payment request type.

19. The method of claim 17, further comprising:
generating an error message if the record is not received in a predetermined manner.

20. The method of claim 17, further comprising:
generating a report that identifies each of the at least one rule that is not met.

21. The method of claim 20, wherein the report is transmitted electronically.

22. The method of claim 17, wherein the formatting characteristic comprises at least one of the following: a length of the record, an alphanumeric requirement associated with the record, and a null data requirement associated with the record.

23. A system for analyzing data relating to an electronic payment request, the system comprising:
an interface to receive a record comprising data relating to an electronic payment request; and
a processor programmed to:
identify a record type associated with the record;
identify at least one rule based upon the record type, wherein the at least one rule relates to at least one formatting characteristic of the data;
determine whether the data relating to the electronic payment request meets the at least one rule; and
generate a report that identifies each of the at least one rule that is not met.

24. The system of claim 23, wherein the electronic payment request relates to electronic payment of funds for the purchase of goods or services.

25. The system of claim 23, wherein the electronic payment request relates to electronic debit of funds for the refund of goods or services.

26. The system of claim 25, wherein:
the processor is further programmed to identify an electronic payment request type associated with the electronic payment request; and
wherein the record type is at least partially based on the electronic payment request type.

27. The system of claim 23, wherein the processor is further programmed to generate an error message if the record is not received in a predetermined manner.

28. The system of claim 23, wherein the interface receives the record by electronic transmission.

29. The system of claim 28, wherein:
the electronic transmission comprises an email delivery; and
a predetermined message is associated with the record.

30. The system of claim 23, wherein the processor is further programmed to transmit the report electronically.

31. The system of claim 23, wherein the formatting characteristic comprises at least one of the following: a length of the record, an alphanumeric requirement associated with the record, and a null data requirement associated with the record.

32. The system of claim 23, wherein the interface further receives a plurality of records related to the electronic payment request.

33. A system for analyzing data, comprising:
interface of the apparatus to receive a record comprising data relating to an electronic payment request; and
a processor programmed to:
identify a record type associated with the record;
identify at least one rule based upon the record type, wherein the at least one rule relates to at least one formatting characteristic of the data; and
determine whether the data relating to the electronic payment request meets the at least one rule;
wherein the system does not process electronic payment transactions for payment.

34. The system of claim 33, wherein the processor is further programmed to:
identify an electronic payment request type associated with the electronic payment request; and
wherein the record type is at least partially based on the electronic payment request type.

35. The system of claim 33, wherein the processor is further programmed to:
generate an error message if the record is not received in a predetermined manner.

36. The system of claim 33, wherein the processor is further programmed to:
generate a report that identifies each of the at least one rule that is not met.

37. The system of claim 36, wherein the processor is further programmed to transmit the report electronically.

38. The system of claim 33, wherein the formatting characteristic comprises at least one of the following: a length of the record, an alphanumeric requirement associated with the record, and a null data requirement associated with the record.

39. A system for analyzing data relating to a hypothetical electronic payment request, the system comprising:
an interface to receive a record comprising data relating to the hypothetical electronic payment request; and
a processor programmed to:
identify a record type associated with the record;
identify at least one rule based upon the record type, wherein the at least one rule relates to at least one formatting characteristic of the data; and
determine whether the data relating to the electronic payment request meets the at least one rule.

40. The system of claim 39, wherein the processor is further programmed to:
identify an electronic payment request type associated with the electronic payment request; and
wherein the record type is at least partially based on the electronic payment request type.

41. The system of claim 39, further wherein the processor is further programmed to generate an error message if the record is not received in a predetermined manner.

42. The system of claim 39, wherein the processor is further programmed to generate a report that identifies each of the at least one rule that is not met.

43. The system of claim 42, wherein the processor is further programmed to transmit the report electronically.

44. The system of claim 43, wherein the formatting characteristic comprises at least one of the following: a length of the record, an alphanumeric requirement associated with the record, and a null data requirement associated with the record.
